(19) United States
(12) Patent Application Publication
(10) Pub. No.: US 2012/0053957 A1
(43) Pub. Date: Mar. 1, 2012

(54) TOOL FOR DETECTING INCONSISTENCIES AND OMISSIONS IN DOCUMENTED JUSTIFICATION FOR MEDICAL SERVICES

(76) Inventors: Lorri Atkins, Fall City, WA (US); Mike DeTolla, Issaquah, WA (US); Murray Rice, Seattle, WA (US); Jeffery Wajda, Medford, OR (US); Igor Tur, Issaquah, WA (US)

(21) Appl. No.: 13/110,237

(22) Filed: May 18, 2011

Related U.S. Application Data
(60) Provisional application No. 61/345,968, filed on May 18, 2010.

(51) Int. Cl. G06Q 50/22

(52) U.S. Cl. 705/2

(57) ABSTRACT

A computerized tool to aid health care workers determine whether health care services proposed for a patient are consistent with policies of a health care facility and adequately justified by documentation, reducing the burden on health care workers of obtaining reimbursement for the services. The tool receives information relating to a diagnosis and risk factors, which may be used to justify planned health care services. Potentially omitted information may be identified based on a disparity between documented risk factors and an assessment provided by a health care worker or a to disparity between identified risk factors and a documented diagnosis. Further, the tool may identify a disparity between proposed services and diagnosis and documented risk, prompting a user to provide more documentation of risk, if appropriate. The tool is configurable such that the comparisons can be based on compliance with policies of a specific health care facility where it is used.

### RELATED APPLICATIONS

This application claims priority to U.S. Provisional Application Ser. No. 61/345,968, filed May 18, 2010, which is incorporated herein in its entirety.

### BACKGROUND

1. Field of the Invention

This invention relates generally to management of health care facilities and more specifically to computerized tools and methods for ensuring that requests for payment for provided services are reimbursed by health care payers.

2. Related Art

Health care providers at many health care facilities spend a large amount of time on activities related to obtaining reimbursement for health care services. These activities involve making decisions on treatment plans for patients based on criteria established by third party payers, such as insurance companies or government entities, that provide reimbursement for health care services. Similarly, time is spent on decisions about other disposition of patients, such as whether treatment involving an admission meets criteria established by a third party payer. Additionally, once decisions are made as to what health care services are to be provided to a patient, the payer may audit the health care provider, requiring the health care provider to provide justification of a decision concerning provided health care services, based on diagnosis or risk factors for the patient.

Computerized tools to assist health care administrators are known. These tools can compare a diagnosis to established payer criteria to indicate, based on a disposition for the patient, whether a health care facility will be reimbursed by the payer.

### SUMMARY

Health care providers may be guided by a tool, as described herein, that determines whether health care services proposed for a patient are consistent with policies established at a health care facility and are consistent with a documented justification for the health care services. The tool may be used to provide real-time decision support to health care workers making admission decisions or other decisions relating to health care services to be provided to a patient. If the tool determines that likely justifications for services have been omitted from documentation for the patient or that the proposed health care are inconsistent with established policies for the health care facility, the health care worker may be prompted to take corrective action. Corrective action may include providing additional documentation to be able to justify the departure from the established policies.

In one aspect, the invention relates to a method of operating a computer system. The method may be performed at least in part by a processor and may include receiving first input indicating a diagnosis of a patient, second input identifying one or more values of factors indicating risk for the patient and third input indicating intended health care services to be provided to the patient. One or more first values may be assigned based on the diagnosis. One or more second values may be assigned based on the one or more values of the factors indicating risk. A combined score may be determined based on the one or more first values and the one or more second values. A health care services score may be determined based on the intended health care services. The determined health care services score may be compared to the combined score, and, based on the comparison, a warning of an inconsistency between the intended health care services and a documented justification for the intended heath care services may be provided.

In another aspect, the invention may relate to a non-transitory computer-readable storage medium comprising computer-executable instructions that, when executed by a processor, perform a method. The method may include receiving diagnosis input indicating a diagnosis of a patient, risk input indicating risk factors for the patient and a disposition input indicating a disposition of the patient. The method may also involve determining whether a documented justification for health care services according to the indicated disposition is suitable based on a comparison of the indicated disposition to the diagnosis input and the risk factor input.

In yet another aspect, the invention may relate to a method of operating a computer system. The method may include operating a processor to receive first input indicating a diagnosis of a patient and second input identifying one or more factors indicating risk for the patient. One or more first values may be assigned based on the diagnosis. One or more second values may be assigned based on the one or more factors indicating risk. A first score computed based on the one or more first values may be compared to a second score computed based on the one or more second values. When the first score is greater than the second score, a user may be prompted to provide input further identifying factors indicating risk for the patient

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch illustrating an exemplary architecture of a system providing a computerized tool according to some embodiments of the invention;

FIG. 2 is a flow chart of a method of configuring the system for a health care facility according to some embodiments of the invention;

FIGS. 3A and 3B, when connected at the points labeled B, are a flow chart of an exemplary method of operation of a computerized tool according to some embodiments of the invention;

FIG. 4A is a sketch of a graphical user interface through which a user may input information relating to a diagnosis according to some embodiments of the invention;

FIG. 4B is a schematic illustration of a data structure associating values with diagnoses that may be customized for a health care facility according to some embodiments of the invention;

FIG. 5 is a sketch of a graphical user interface through which a user may input information relating to a condition of a patient according to some embodiments of the invention;

FIG. 6 is a sketch of a graphical user interface through which a user may input information relating to risk factors according to some embodiments of the invention;

FIG. 7 is a schematic representation of a data structure associating values with risk assessments that may be that may be customized for a health care facility and accessed by a tool according to some embodiments of the invention;

FIG. 8 is a schematic illustration of a data structure associating scores with risk factors for a diagnosis that may be accessed by a tool that may be customized for a health care facility according to some embodiments of the invention;

FIG. 9 is a sketch of a graphical user interface through which a user may be prompted to provide additional documentation justifying a plan of health care services according to some embodiments of the invention;

FIG. 10 is a sketch of a graphical user interface through which a user may provide information on a plan of care as part of intended health care services to be provided to a patient;

FIG. 11 is a sketch of an output that may be produced by the tool according to some embodiments of the invention;

FIG. 12A is a sketch of a graphical user interface through which a user may define an intended disposition of a patient as part of an intended plan for health care services;

FIG. 12B is a schematic illustration of a data structure that may be accessed by a tool according to some embodiments of the invention to determine whether an intended plan for health care services is consistent with provided documentation; and

FIG. 13 is a schematic illustration of a data structure for use by a tool to generate messages to a user according to some embodiments of the invention.

### DETAILED DESCRIPTION

The inventors have recognized and appreciated that significant advantages in administration of health care facilities may be achieved with a computerized tool that increases the likelihood that a plan for health care services will result in reimbursement from a third party payer. The inventors believe that existing tools are inadequate because they are designed for use after a patient disposition has been determined Such tools are used at a time when easy access to information that might justify the disposition for a particular patient might no longer be available. Further, existing tools cannot alert a health care worker to scenarios in which a plan of treatment has been recommended that departs from norms established by a health care facility or third party payer and guide a health care worker in documenting such a treatment decision.

A tool according to some embodiments of the invention may aid a health care worker document justifications for health care services existing for a patient, such as by obtaining information about a diagnosis for the patient, risk factors for that patient and intended health care services to be provided to the patient. The tool may alert a health care provider to inconsistencies or omissions in documented justifications that may result in denial of payment from a third party payer and allow the health care provider to take corrective action. The tool may also archive the information collected about the patient as documentation justifying an intended plan for health care services such that it can be available to defend an audit by a third party payer.

The tool may be configured for a health care facility. The tool may be configured by specifying values used in computing scores representing criteria used in detecting inconsistencies or omissions. These scores, for example, may indicate a severity of a diagnosis, the level of documentation of risk factors and the extent of health care services planned for a patient. Decisions based on comparisons of these scores may therefore be customized on a facility-by-facility basis.

Multiple types of comparisons, based on these values, can be made to identify possible inconsistencies or omissions in documented justifications for health care services. In some embodiments, these values may be used to generate a first score representing a severity of a diagnosis. Based on available information on risk factors, a second score representing a level of documented risk may be computed. If these scores indicate that the level of documented risk is low relative to the severity of the diagnosis, a user may be prompted to provide further input justifying the diagnosis. Another approach for identifying inconsistencies or omissions may involve the tool receiving from a health care provider an overall assessment of a patient's risk and comparing that assessment to risk factors documented.

Yet another approach for identifying inconsistencies or omissions may involve computing an aggregate documented justification score, based on both the documented diagnosis and risk factors. This score may be compared to an intent score, representing a score representing a level of health care services planned for the patient. Though, it should be appreciated that different or additional approaches may be used to identify possible inconsistencies or omissions in documented justifications for health care services.

Regardless of the approach used to identify such inconsistencies or omissions, the tool will alert a user. Such a warning may be provided in connection with prompts for the user to take corrective action. The prompts may include a request for omitted information or a request to explain an inconsistency. Alternatively or additionally, a prompt may include a suggestion for a health care worker to review any of the information input to the tool, including a plan for health care services.

A tool according to embodiments of the invention may be implemented in any suitable way. In some embodiments the tool may be implemented in a stand alone computer system containing computer-executable instructions that generate user interfaces through which one or more users may provide inputs and receive outputs from the tool. The computer-executable instructions may also perform processing on the inputs and other data to identify inconsistency or possible omissions in the information provided by the users. Additionally, such a stand alone computer may contain memory, holding data structures used in processing inputs and generating outputs by the tool.

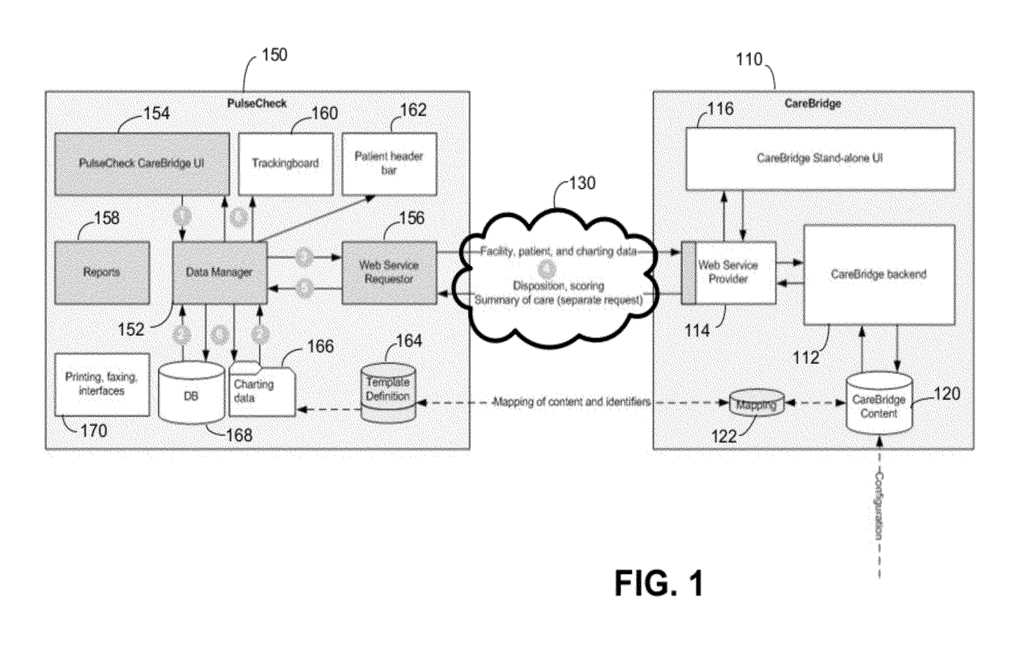

However, in other embodiments, the tool may be implemented as a web service, using programming techniques as are known in the art. Further, the tool may interact with or be integrated with one or more other clinical data management systems. In this scenario, some inputs to the tool may be acquired from those clinical data management systems without express user input. Similarly, some outputs from the tool may be provided to the other clinical data management systems rather than to a user directly. FIG. 1 illustrates an exemplary architecture of such a system.

The system of FIG. 1 includes web service 110 on which all or portions of a tool according to some embodiments of the invention may execute. Web service 110 may be implemented on one or more web servers, each comprising one or more processors configured to implement the functions of web service 110. Web service 110 may be coupled to a clinical data management system 150 over network 130. As a result of this coupling, data may be exchanged between clinical data management system 150 and web service 110 to perform operations of the tool, as described herein.

Web service 110 may include backend 112. Backend 112 may be implemented as computer executable instructions generated using programming techniques as are known in the art to perform the functions as described herein. Backend 112 may be coupled to a web service provider 114. Web service provider 114 may provide an interface through which web service 110 may exchange data over network 130 with clinical data management system 150 in a healthcare facility.

In the embodiment illustrated, network 130 may be a public network, such as the Internet. Security mechanisms may be employed to create secure channels for communication between web service 110 and clinical data management system 150. Though, components to provide those security mechanisms are not shown for simplicity.

Through web service provider 114, backend 112 may obtain information from a healthcare facility concerning a patient. This data may be the type of data that is normally maintained in clinical data management system as part of providing health services to the patient. That data may include information input by a healthcare provider, such as a diagnosis. The information may also include observations made concerning the patient's physical or emotional state. Other information maintained in a clinical data management system 150 may include lab results. Though, any suitable type of information may be maintained and may be accessed for performing operations on backend 112.

Further, the information available from clinical data management system 150 may include a proposed plan for providing health care services to the patient, including a treatment plan or an intended disposition, such as outpatient treatment or hospital admission.

In return, web service provider 114 may provide to clinical data management system 150 information obtained or generated by backend 112 during operation of the tool. Such information may include a disposition or summary of care determined based on inputs from the user. Such information may also include scoring, indicating whether there are inconsistencies among diagnosis, documented level of risk or extent of health care services planned for a patient. Though, any suitable type of information may be exchanged through web service provider 114 with other health care data management systems.

In operation, one or more users may interact with the tool through one or more user interfaces. Through such interactions, a user, such as a health care worker, may provide information about a diagnosis, condition, risk factors, or planned health care services related to the patient. Through such interactions, a user may receive information or warnings about inconsistencies or omissions in documented justifications for providing health care services.

This interaction may be through user interface 116 associated with web service 110. In some embodiments, user interface 116 may interact with a user through input/output devices associated with a server or other hardware devices on which web service 110 executes. In other embodiments, user interface 116 alternatively or additionally may interact with users over network 130. In such an embodiment, user interface 116 may generate and process received messages in a format as is known in the art for providing a user interface over a network. As a specific example, user interface 116 may exchange messages in a format conventionally used by a client device configured with a browser. Accordingly, it should be appreciated that user interface 116 may be implemented using any suitable technology for providing a user interface, and the location of the input/output device on which the user interface appears is not a limitation of the invention.

Though, a tool as described herein may also interface with one or more users based on user interface 154 that is part of clinical data management system 150 or in any other suitable way.

In the embodiment illustrated, web service 110 may be adapted to interface with multiple health care facilities. Though, web service 110 may be customized for each heath care facility, such as through the use of data maintained as part of web service 110 that is associated with each health care facility serviced by web service 110.

FIG. 1 illustrates that web service 110 also includes a data store 120. Data store 120 may contain information accessed by backend 112 during operation of the tool. A portion of the data in data store 120 may facilitate interactions with users and systems in designated healthcare facilities. Accordingly, data store 120 may contain access control information, as is known in the art, allowing multiple users and healthcare facilities to access web service 110 using different information to customize operation of the tool for their use.

Another portion of the data in data store 120 may be configuration information associated with different health care facilities. Such configuration information may be based on policies or other preferences for each healthcare facility. Though FIG. 1 shows, as a simplified example, a single healthcare facility interacting with web service 110, multiple healthcare facilities may access web service 110. Accordingly, the information configuring the tool for a healthcare facility may be stored in data store 120 associated with a specific healthcare facility. When backend 112 interacts with that healthcare facility, it may access the appropriate content from data store 120, such that interactions between backend 112 and each healthcare facility may be customized.

Configuration information may be added to data store 120 in any suitable way. In some embodiments, a healthcare administrator associated with a healthcare facility for which clinical data management system 150 maintains information may provide information that leads to configuration of the tools provided by web service 110. In some embodiments, user interface 116 may provide a mechanism for a healthcare administrator of a healthcare facility to provide inputs that customize the tool in accordance with policies maintained by the healthcare facility. However, the configuration information in data store 120 may be generated and stored in any suitable way.

Other information may be maintained by web service 110 to facilitate interaction with multiple health care facilities. For example, data store 122 may maintain customization information. In some scenarios, a clinical data management system 150 may include information of the type used by backend 112 stored in a format different than is used by backend 112. To facilitate use of this data, data store 122 may store a mapping for each clinical data management system to interact with web service 110. The mapping may specify rules or other criteria for formatting information obtained from clinical data management system 150 such that, upon application of a mapping from data store 122, backend 112 may use data from clinical data management system 150.

The mapping in data store 122 may be created in any suitable way. In some embodiments, the mapping for each healthcare facility may be created at the time the healthcare facility subscribes to the service provided by web service 110. Such a mapping may be readily created by a human programmer. Though, a mapping may be created in any suitable time and any suitable way.

Clinical data management system 150 may be any suitable system that maintains information about patients or other aspects of a healthcare facility. However, as a specific example, clinical data management system 150 may maintain information of the type collected in the emergency department of a hospital.

In the embodiment illustrated, clinical data management system 150 includes a data manager 152 to maintain information of the type conventionally maintained in the emergency department of a hospital. Data manager 152 may collect information about patients within the healthcare facility and present multiple reports used in providing patient care or administering the health care facility.

Clinical data management system 150 may contain one or more data stores to hold this information. Though interactions relating to a single patient are described, these data stores may contain data about all of the patients of a health care facility. Access mechanisms, which may be of a type known in the art and are not illustrated for simplicity, may ensure that data related to a relevant patient is selected from the data stores.

In this example, clinical data management system 150 includes data stores 166 and 168, each of which may contain data about patients. Data store 166 may contain charting data of the type conventionally maintained in a healthcare facility, including data representing observations about the physical or mental state of the patient entered by a healthcare worker, information about lab test results or any other suitable type of data. Data store 168 may contain other information about patients, about the health care facility or about other topics.

Data stores 166 and 168, in addition to providing access to information used by healthcare providers in determining a plan for health care services for a patient, may be maintained as a data archive. Such information may be used, for example, to generate bills to third party payers for services provided and to provide justification for those bills if the health care facility is audited by third party payers. Accordingly, a result of using the tools provided by web service 110 may be to ensure that the data contained in data stores 166 and/or 168 provides justification for the services provided to each patient.

In the embodiment illustrated, data manager 152 may manage storing and retrieving information from data stores 166 and 168. The information in data stores 166 and 168 may be obtained in any suitable way, including as a result of user input. As a specific example, information may be obtained through user interface 154. User interface 154 may provide user interfaces at terminals throughout a healthcare facility, such that one or more healthcare providers may interact with the system, providing information about patients or obtaining information about patients. Such interfaces may be in a form as are known in the art.

Though, in the system illustrated in FIG. 1, data manager 152 also may obtain data from and provide data to web service 110. Data manager 152 may interact with web service 110 through web service requestor 156. Web service requestor 156 may be implemented using technology as is known in the art, including programming using a known protocol, such as SOAP.

Regardless of the mechanism of interaction, data manager 152 may have access to information generated by backend 112 concerning inconsistencies or omissions in information relating to diagnosis, documented risks or planned health care services for a patient. In addition to storing this information in data stores 166 and 168, data manager 152 may present this information to one or more users through user interface 154. In reverse, data manager 152 may provide information to web service 110, whether that information is obtained from data stores 166 and 168, through user interface 154 or obtained in other suitable way.

To facilitate translation from data in a format maintained by web service 110 to a format maintained by clinical data management system 150, clinical data management system 150 may maintain templates that allow data from web service 110 to be reformatted in a format used by clinical data management system 150. Data store 164 may contain information to facilitate access to data used by web service 110. In this example, data store 164 includes templates that can be used to format data from web service 110 for storing in data store 166. Though, any suitable translation mechanism may be used.

Data manager 152 may interact with components of a clinical data management system as is known in the art. Those components may include tracking board 160, patient header bar 162, report generator 158 or interfaces 170 such as may facilitate printing or faxing of information from the clinical data management system 150. These components, for example, may provide information about patients, at appropriate locations and in appropriate formats throughout a health care facility. These components may be as are known in the art or may be modified to facilitate functions of the tool to detect inconsistent or omitted documented justifications for a plan of health care services. For example, report generator 158 may obtain data from data manager 152 and generate reports of any suitable types. Those reports may include reports on the adequacy of documentation for health care services to be provided to a patient or may include that documentation, itself, and may be used in defending an audit of a request for reimbursement for health care services.

It should be appreciated that FIG. 1 illustrates just one example of a system through which a tool may access information to identify inconsistencies and omissions relating to documentation justifying health care services. Other mechanisms for obtaining information may alternatively or additionally be employed.

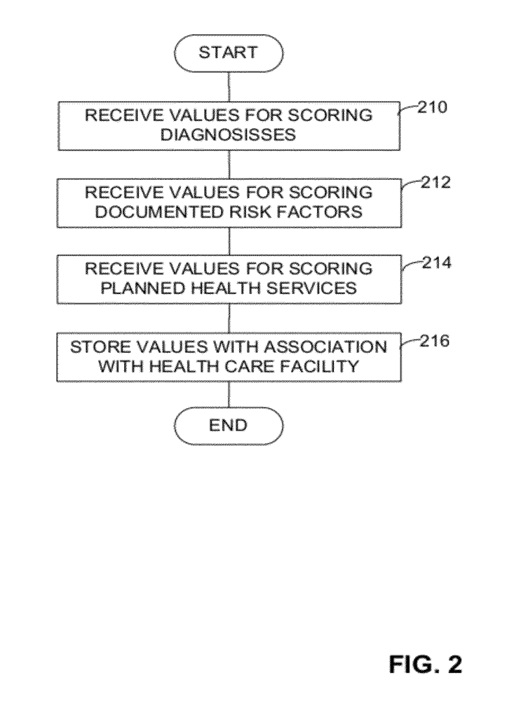

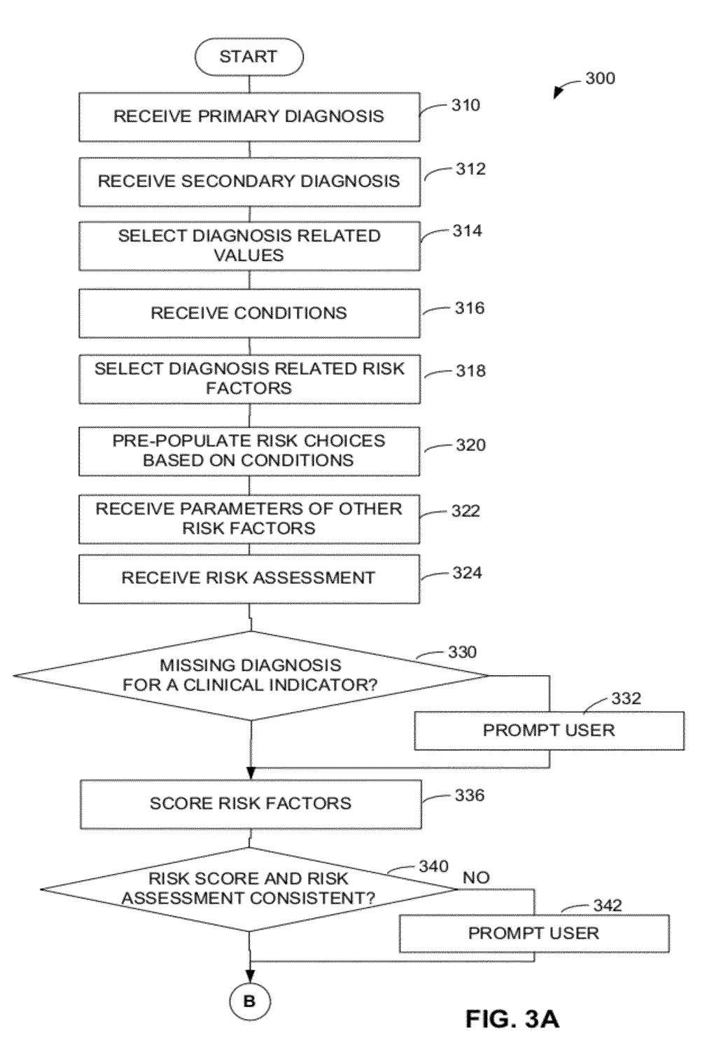

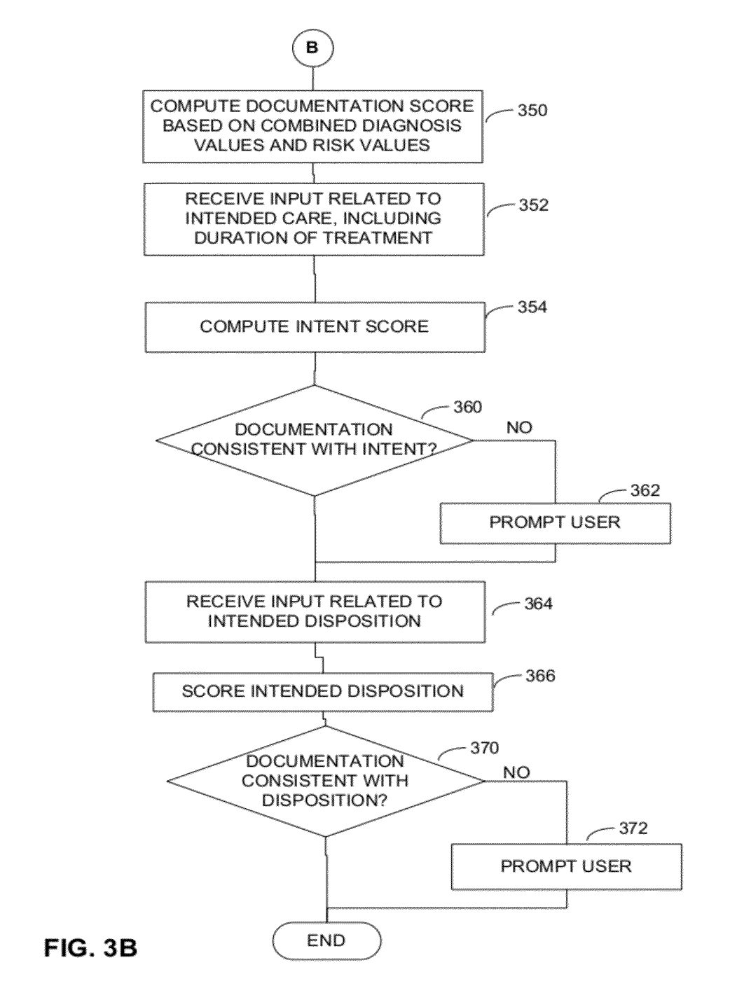

Regardless of the system in which a computerized tool according to some embodiments of the invention is implemented, it may be operated as illustrated in FIGS. 2, 3A and 3B. FIG. 2 illustrates a process of configuring the tool for operation in accordance with policies of a health care facility. The process of FIG. 2 may be repeated for each healthcare facility to access the tool. Each facility, for example, may be a hospital. Though, configuration may be performed for a hospital system containing multiple hospitals. Conversely, configuration may be performed for a unit of a hospital, such as an emergency department. Accordingly, it should be appreciated that the specific nature of the healthcare facility for which the tool is configured is not critical to the invention.

The configuration process illustrated in FIG. 2 begins at block 210. At block 210, the tool receives values for scoring diagnoses. The information may be obtained in any suitable format from any suitable source. Though, in some embodiments, data store 120 may be loaded with a data structure, such as an XML file, listing known diagnoses and providing a location for one or more values to be associated with each diagnosis. In some embodiments, the values may be input through a user interface 116. These values may be generated, for example, by a chief medical officer or a lead physician in a healthcare facility. Though, the values may be obtained from any suitable source in any suitable way.

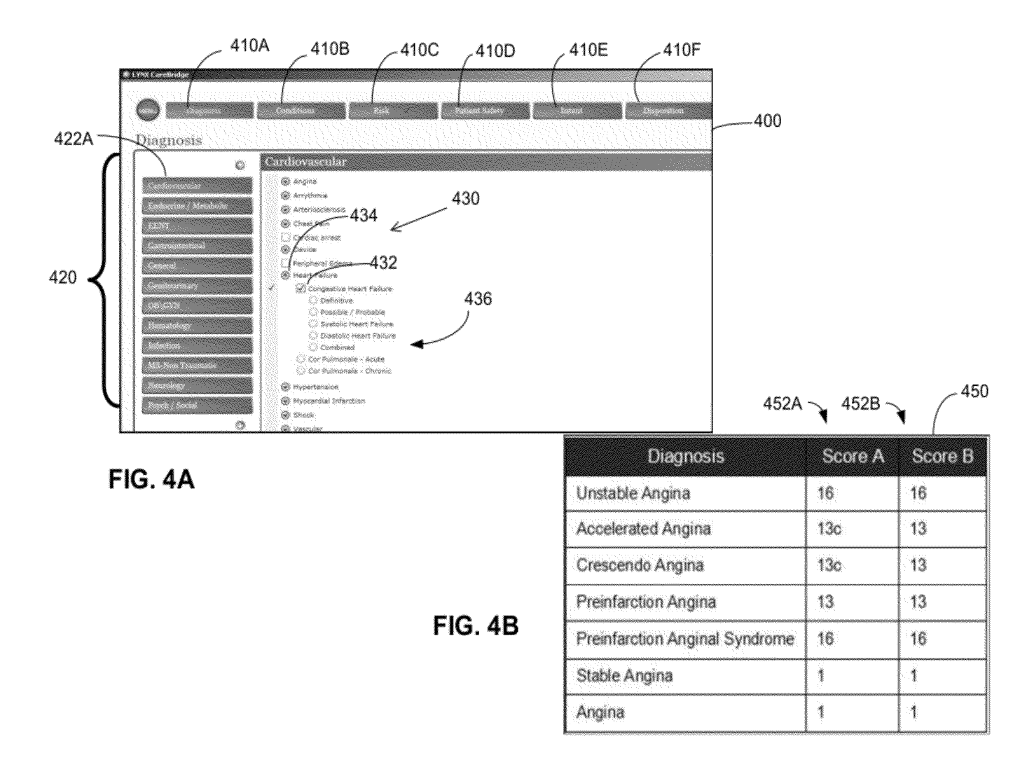

FIG. 4B is a schematic illustration of a portion of a data structure 450 that may be used for receiving values for scoring diagnoses. Such a data structure may also serve as a source of data when presenting lists of diagnoses to a user. As can be seen by the example of FIG. 4B, the data structure may be organized in a way that associates one or more values with each diagnosis. In this example the data structure has multiple rows, each row associated with a diagnosis. As illustrated, the data structure 450 contains two columns in which values may be entered for each diagnosis. Column 452A contains a value that is applied when an associated diagnosis is a primary diagnosis for a patient. Column 452B contains a value similarly applied when the associated diagnosis is a secondary diagnosis for a patient. These values may be used by a computerized tool to compute an indicator of a severity of a diagnosis for a patient, as described in further detail below.

Returning to FIG. 2, the process of configuring a computerized tool may proceed to block 212. At block 212, the tool may receive values for scoring risk factors identified for a patient. As with the values received at block 210, the values received at block 212 may be provided by a chief medical officer or lead physician through graphical user interface 116 (FIG. 1) or received in any other suitable way. Regardless of how received, the values received at block 212 may be used in determining an extent to which risk factors that have been documented for a patient justify a plan for health care services.

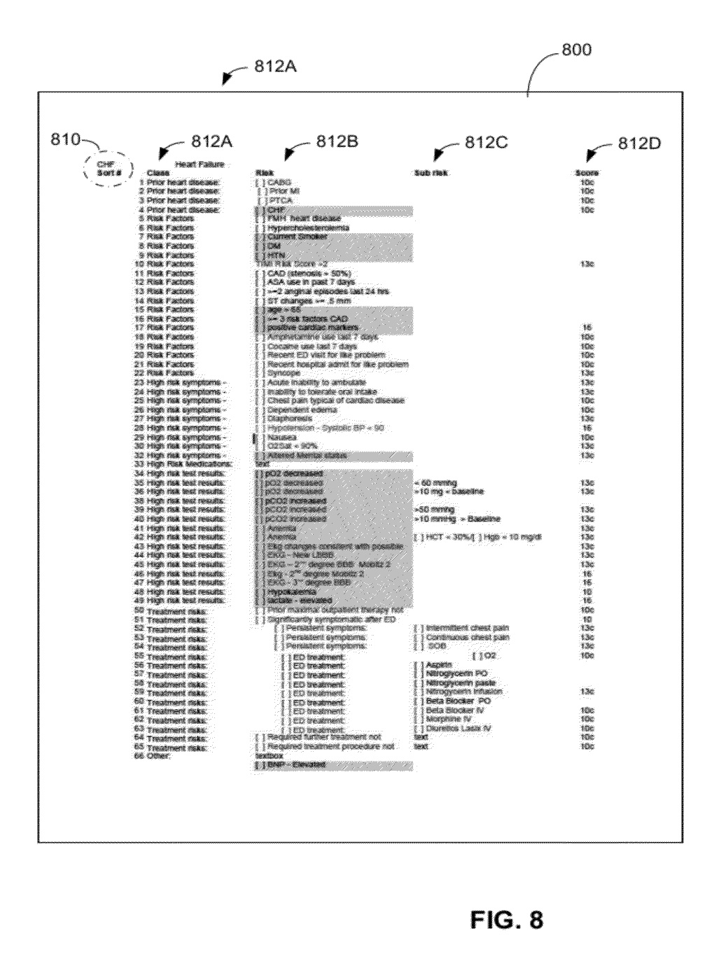

The values for scoring risk factors may be organized and stored in any suitable way. Though, as an example, FIG. 8 illustrates a portion of a data structure 800 that may be stored in data store 120. In the example of FIG. 8, data structure 800 is organized into sections, each associated with a possible diagnosis. FIG. 8 illustrates a portion of the data structure associated with diagnosis 810, in this example, congestive heart failure (CHF). Though not shown in FIG. 8, a similar portion of a data structure may exist for each other possible diagnosis that the tool is programmed to recognize.

Data structure 800 may be organized in any suitable way to show relationships between values of risk factors and values used for determining a score representing the extent to which patient risk has been documented when the patient's chart or other archive indicates the risk factor is present. In this example, data structure 800 is organized into four columns 812A, 812B, 812C and 812D. Each row of the data structure provides information about a risk factor. The information in column 812A for each row identifies a class of that risk factor. The information in column 812A may be used for grouping risk factors in a user interface or for other purposes.

The information in column 812B identifies the risk factor. The specific risk factors in data structure 800 may be generated based on known risk factors associated with diagnosis 810. These risk factors may relate to patient symptoms, patient history, lab test results or any other factors that may be used by a healthcare professional to determine an appropriate plan for health services based on diagnosis 810.

Column 812C includes sub-risk factors. In some instances, the risk factors in column 812B may be regarded as having a greater or lesser degree of severity depending on a value of some parameter associated with the risk factor. In the illustrated embodiment, ranges of parameter values that are associated with different levels of risk are represented as sub-risk factors in column 812C. As an example, a decreased level of blood oxygen may be regarded as a risk factor identified in column 812B. Different scores may be associated with difference ranges of decreased blood oxygen levels. Column 812C may be used to specify different ranges of decrease in blood oxygen level.

By identifying risk factors and sub-risk factors, the risk factors may take on binary values indicating whether the risk factor/sub-risk factor combination is present or not. Though, it should be appreciated that in other embodiments, risk factors having different levels of risk associated with different values of a parameter associated with the risk factor may be reflected in other ways. In these embodiments, non-binary values may be used and these values may be indicated in any suitable way.

Column 812D may contain, for each row in data structure 800, a score. This score may be used in assessing a level of documented risk when patient data, such as charting data 166 (FIG. 1), indicates that a patient has an associated risk factor, as identified in column 812B and, if applicable, a sub-risk factor as identified in column 812C.

Returning to FIG. 2, the process of configuring a tool for a health care facility may proceed to block 214. At block 214, values for scoring planned health services may be received. As with the values received at blocks 210 and 212, the values received at block 214 may be input through a user interface in any suitable way, including by having a healthcare administrator enter values in a data structure that is partially populated with possible plans or possible components of a plan for health services. The possible plans or components of a plan for health services may be represented in any suitable way and values for any suitable number of possible plans may be obtained.

Though, in some embodiments, a primary objective of using a computerized tool as described herein may be to determine whether a decision to treat a patient as an inpatient in a hospital is justified. Such a decision may also be expressed as whether the plan for health services involves treatment at the health care for facility for longer than 24 hours, which may be regarded as admission to the facility.

In this embodiment, a relatively small number of components of a plan for health services may be relevant—namely, whether a patient will be admitted to the health care facility. In this scenario, a data structure containing values for scoring intended health services may contain values for a limited number of categories of health service plans. A value may be provided, for example, for a plan including less than 24 hours of documented interventions and a different, higher value, may be provided for plans for health services including more than 24 hours of documented interventions. Though, the specific nature of the plans or components of the plans for health services for which values are obtained is not critical to the invention.

Once information is collected at blocks 210, 212 and 214, it may be stored by the tool with an association to the healthcare facility for which the information was provided. In this way, when web service 110 (FIG. 1) interacts with a specific healthcare facility, the web service 110 will make assessments on documented justifications for health care services based on values specifically provided for that healthcare facility. These values may be set to reflect policies of the health care facility.

Once the tool is configured as illustrated FIG. 2, it may thereafter be used to analyze data relating to specific patients at the healthcare facility. As a result of the analysis, the tool may generate indications that may be used to alert a user to possible inconsistencies or omissions in entered data. The inconsistencies, for example, may indicate that a level of documented risk is low relative to a severity of a diagnosis. Alternatively or additionally, the tool may alert the user that the extent of planned health services is high in relation to a diagnosis and/or documented level of risk. An omission may be identified, for example, if a user provides an overall risk assessment that is different from a risk assessment that could be inferred from documented risk factors. The tool may identify such inconsistencies or omissions in accordance with a process illustrated in FIGS. 3A and 3B.

FIG. 3A is the beginning of a flowchart of an exemplary process that may be performed by the tool in analyzing data for a patient. In the embodiment illustrated in FIG. 1, process 300 may be implemented by interaction of web service 110 and clinical data management system 150. Though the partitioning of the functions occurring during process 300 is not critical to the invention, functions relating to receiving information about a patient and a plan for health care services for the patient may be received through clinical data management system 150, including through user interface 154. Functions relating to determining whether justification for the planned health care services are adequately documented may be performed within backend 112 of web service 110. Though, as illustrated in FIG. 1, clinical data management system 150 and web service 110 may exchange information over network 130 such that any suitable partitioning of the functions may be supported. Accordingly, implementation of the tool may be distributed over processors and other hardware forming web service 110 and clinical data management system 150 or performed in any other suitable components.

Process 300 may begin in response to an event that occurs during an initial examination of a patient. This process may start based on user input expressly invoking the tool or other actions, such as an indication from clinical data management system 150 that a patient is in the healthcare facility for treatment. Such an event may occur, for example, when a patient is brought into an emergency department of a hospital. Though, it should be recognized that the tool may be employed in other settings such that the process 300 of gathering and analyzing data associated with a patient may begin in response to other events.

Process 300 involves interaction with a user of the tool, which may be a healthcare worker, such as a doctor, in a healthcare facility. As part of those interactions, the tool may obtain inputs from the user and provide outputs related to a plan of health care services and documented justifications for the plan of health care services. Those interactions with a user may be made in any suitable way. Though, in the illustrated embodiment, the interactions may be performed through a graphical user interface, such as graphical user interface 400 in FIG. 4A. Such a graphical user interface may be presented to a healthcare worker using the tool through user interface 154 or in any other suitable way.

A graphical user interface through which a user may input and receive information may be structured in any suitable way. Though, in the embodiment illustrated, graphical user interface 400 includes multiple control objects by which a user of the tool may select a limited amount of information to appear on graphical user interface 400 at any given time. These control objects included in such a graphical user interface may allow a user to select information displayed at any time based on a function to be performed by the user.

For example, graphical user interface 400 includes tabs 410A, 410B, 410C, 410D, 410E and 410F. Each of the tabs may be activated by the user, using a mouse or other suitable input device, to select a category of information that appears in other portions of graphical user interface 400. In this example, tab 410A is associated with diagnosis information. In the configuration illustrated in FIG. 4A, a user has selected tab 410A and graphical user interface 400 is configured to capture information relating to a diagnosis.

Others of the tabs 410A . . . 410F, when selected by a user, may configure the graphical user interface for performing other functions associated with the tool. As described in more detail below, when a user selects tab 410B, graphical user interface 400 may be configured to provide a user with information concerning documented conditions or receive user input relating to observed conditions of the patient. When a user selects tab 410C, the graphical user interface may be configured to provide the user with information about documented risk factors and to receive user input about risk factors that may exist for the patient. When the user selects tab 410D, the user interface may be configured to present information to the user about documented factors that may impact patient safety if treated on an outpatient basis and to receive input documenting additional factors. When a user selects tab 410E, the graphical user interface 400 may be configured to provide information to the user about an intended plan of care for the patient and to receive user input adding or modifying the interventions included in the intended plan of care. Similarly, when the user selects tab 410F, the graphical user interface may be configured to present information to the user about an intended disposition of the patient and to receive user input to add or alter information concerning the intended disposition. In the embodiment illustrated, the intended disposition may relate to hospital admission, distinguishing between scenarios in which the intended disposition includes treatment on an outpatient basis and treatment during a hospital stay of twenty four hours or more. Though, in other embodiments, other dispositions or other aspects of planned health care services may be relevant, and graphical user interface 400 may be configured in response to user selection of tab 410F to display and obtain information relating to those aspects.

More generally, the tabs 410A . . . 410F illustrate functional groupings of information that may be collected and presented to a user as part of determining whether documented justifications for a plan of health care services are adequate and, when they are not, prompting the user to take corrective action. Accordingly, it should be recognized that the specific tabs illustrated in FIG. 4A are illustrative and other tabs, relating to other functional organizations of input and outputs of information from a tool, may be provided in other embodiments.

At block 310, user interactions may provide information related to a primary diagnosis for the patient being processed. The information relating to the primary diagnosis may be received through a graphical user interface, such as graphical user interface 400 (FIG. 4). The configuration of graphical user interface 400 may be created by a user selected tab 410A or in any other suitable way.

In the embodiment illustrated in FIG. 4A, a user is constrained to entering inputs identifying one or more diagnoses that the tool is programmed to recognize because the tool presents a list of possible diagnoses in display area 430 from which a user may make a selections. The possible diagnoses presented in display area 430 may be selected in any suitable way. As an example, each possible diagnosis may be reflected in a data structure of the type illustrated in FIG. 4B.

In some embodiments, user input may be made by selecting a control element associated with a possible diagnosis. As illustrated, display area 430 contains a list of diagnoses, each diagnosis associated with a control element, such as control element 432, that may be selected by the user using a mouse or other suitable input device.

The list and control elements may be organized in any suitable way. In this example, the possible diagnoses are organized hierarchically such that, upon selection of a diagnosis having possible subcategories, a user may be provided with a sub-list of qualifications or refinements on the diagnosis. For example, control element 434, in the example of FIG. 4A, is shown associated with the diagnosis “heart failure.” Upon selection of control 434, a user may be presented with a sub-list 436 containing control element 432, which, in this example, a user may select to indicate a diagnosis of “congestive heart failure.” In this case, the diagnosis of congestive heart failure has possible qualifications that are listed in display area 430. Those possible qualifications include, as an example, “definitive,” “possible/probable,” “systolic heart failure,” “diastolic heart failure” and “combined.” Each of these possible qualifications is associated with a control element, which may also be selected, allowing a user to refine the diagnosis of “heart failure.” Other diagnoses listed in display area 434 may similarly have control elements, such as control 434, allowing a user to see subcategories and qualifications at any suitable level of detail so that an appropriate diagnosis may be selected.

To further aid a user in selecting an appropriate diagnosis, graphical user interface 400 may be configured with a control area 420 through which a user may select from among multiple broad categories of diagnoses. In the configuration illustrated, a user has selected control 422A associated with the cardiovascular system. Accordingly, the possible diagnoses presented in display area 430 relate to conditions of the cardiovascular system. Other control elements in display area 420 may be selected by a user to view possible diagnoses in other areas.

The hierarchical presentation of diagnoses as illustrated in FIG. 4A may provide a useful mechanism for allowing a user to quickly select one or more diagnoses that may apply to a patient. Though, it should be appreciated that any suitable format for receiving input at block 310 may be used to receive a primary diagnosis for a patient.

In some embodiments, a tool may recognize more than one diagnosis. In such a scenario, a primary diagnosis may be recognized. One or more secondary diagnoses may also be specified by a user. Secondary diagnoses may be specified in any suitable way. As one example, a user may select multiple diagnoses in display area 430. If a user enters multiple diagnoses, the tool may prompt the user to identify the primary diagnosis. Though, any suitable mechanism may be used to obtain the input at blocks 310 and 312.

Once a diagnosis or diagnoses have been specified, the process may proceed to block 314 where values associated with each diagnosis are obtained. In the embodiment illustrated, the list of possible diagnoses presented to a user is based on a data structure, such as data structure 450 associating a value with each possible diagnosis. Accordingly, when processing reaches block 314, a set of values may be associated with each diagnosis made for a patient. For the diagnosis identified as a primary diagnosis, a corresponding value may be selected from column 452A of the data structure 450. For each diagnosis identified as a secondary diagnosis, a value may be selected from column 452B (FIG. 4B). These values may be used subsequently in the process 300 for making comparisons to identify inconsistent or omitted information.

Once values associated with each diagnosis have been selected at block 314, process 300 may proceed to block 316. At block 316, information on conditions affecting the patient may be obtained. This information may be obtained from a data store, such as data store 166 or 168 (FIG. 1) or obtained by user input.

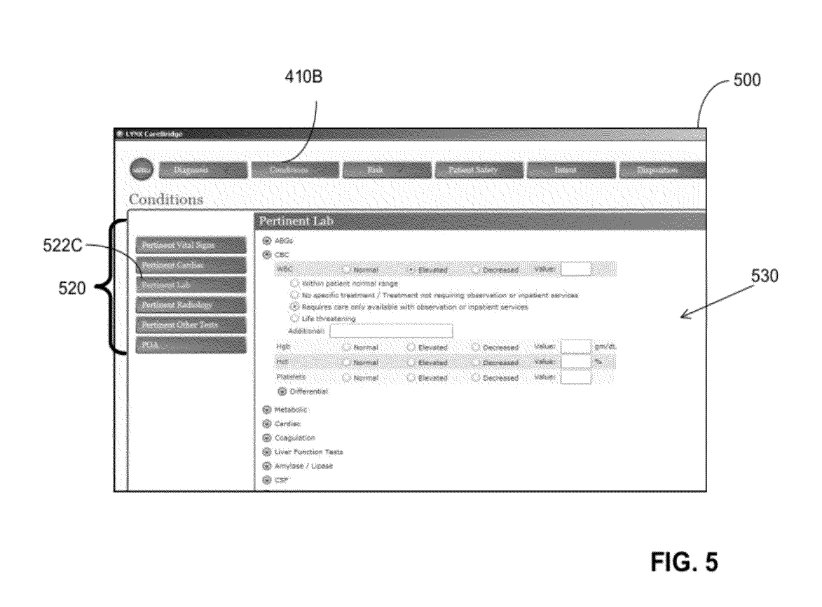

FIG. 5 illustrates that information relating to patient conditions may be obtained through graphical user interface 400 by selection of tab 410B. Upon selection of tab 410B, the tool may configure graphical user interface 400 with a sub-area 520 presenting a user with controls that allow the user to select a category of conditions. FIG. 5 shows graphical user interface 400 configured after selection of control 522C, relating to conditions reflected by laboratory test results. Upon selection of control 522C, display area 530 may be configured to present information relating to laboratory test results that are relevant based on the diagnoses selected at blocks 310 and 312. Though, any suitable mechanism may be used to determine the nature of conditions displayed in the user interface.

As with the display of diagnoses in display area 430, possible laboratory results may be displayed hierarchically in display area 530. User interface controls may be associated with subcategories of laboratory results, which, if selected by a user may create a sub-list of possible results. Furthermore, the tool may be programmed to display fields or other control elements through which a user may input or change values for laboratory results. Though, it should be appreciated that any suitable mechanism may be used to receive inputs defining an observed condition of the patient.

Once input relating to conditions has been received at block 316 the process may proceed to block 318 where risk factors associated with the conditions identified may be selected. For example, results of certain laboratory tests in abnormal ranges may indicate a risk factor for a person having a particular diagnosis. These conditions, and the risk factor represented by them, may be selected at block 318.

The risk factors may be made in any suitable way. Though, as described above, the tool may be programmed with a data structure 800 (FIG. 8) listing risk factors associated with each diagnosis. Once diagnoses are received at block 310 and 312, the tool may access such a data structure to identify risk factors applicable to that diagnosis. The applicable risk factors may be compared to the conditions received at block 316. If any of the applicable risk factors is present based on the indicated conditions, those risk factors may be selected at block 318.

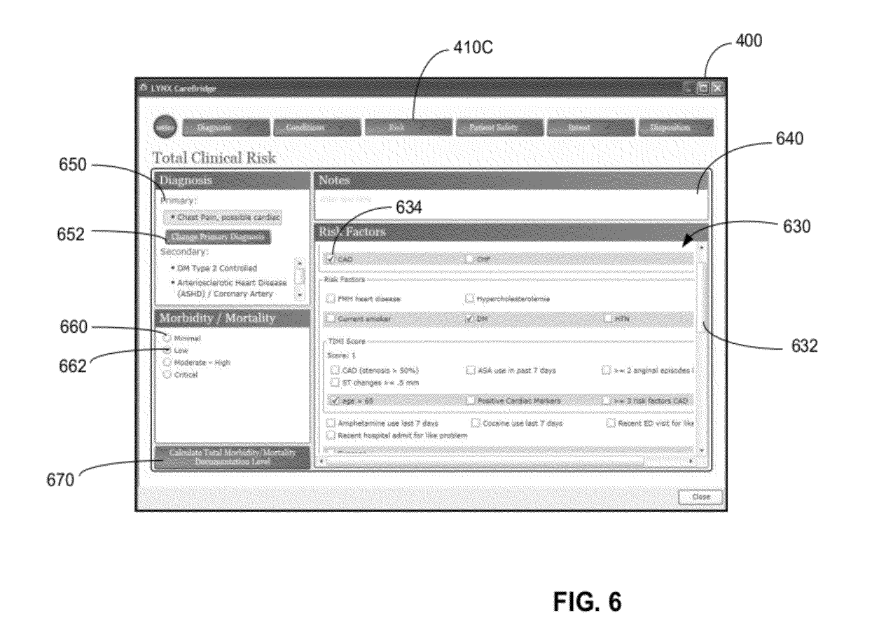

The risk factor selected at block 318 may be used at block 320 to pre-populate risk choices displayed to a user. In the embodiment illustrated, information about risk factors may be presented through graphical user interface 400 when a user selects tab 410C. Graphical user interface 400 configured in this manner is illustrated in FIG. 6. In the scenario illustrated in FIG. 6, the user has selected tab 410C such that the tool has configured graphical user interface 400 with a display area 630 listing risk factors potentially applicable to a patient. In the embodiment illustrated, the tool selects specific risk factors based on the diagnoses provided for the patient. In this case, information about the diagnoses is presented, such as in display area 650, which presents the primary and, if applicable one or more secondary diagnoses. A control, such as control 652 may be present to allow a user to change the diagnosis indicated as a primary diagnosis.

In addition to allowing a user to view risk factors that have been identified, graphical user interface 400 configured as in FIG. 6 allows a user to modify the set of risk factors applicable to a patient by providing input that adds or modifies risk factors. At block 322, user inputs may be received in which a user identifies other risk factors applicable to a patient. In this example, each possible risk factor presented through graphical interface 400 may be presented in association with a control, such as control 634, which may be selected by a user to indicate whether a risk factor is present for a patient. Conversely, when selected, such a control may be deselected to indicate that the risk factor is not present.

The risk factors presented in display area 630 may be presented in any suitable way. In the example illustrated in FIG. 6, display controls, such as scroll bar 632 may be included in display area 630, allowing a user to scroll through a list of multiple possible risk factors that may be selected or deselected based on an evaluation of a patient. In this way, a user may scroll through options for risk factors, indicating that certain risk factors are or are not present for the patient. The identification of risk factors in this fashion may serve as documentation of the patient's condition which may, if indicating a sufficiently high level of risk, justify a plan of health care services for the patient.

When configured to allow a user to manipulate information relating to patient risk, graphical user interface 400 may additionally include a display area 640. Display area 640 may be a note field, allowing a user to input information about identified risk factors not captured by selections made in display area 630. Input in display area 640 may be made, for example, by a user typing or otherwise providing text based input. The information in both display areas 630 and 640 may be archived in connection with a patient record. If a plan of treatment for the patient is questioned by a third party payer, the archived information concerning risk factors documented through display areas 630 and 640 may be available to justify the plan for providing health care services. Additionally, the information received through display area 630, relating to identified risk factors, may be used in an automated assessment of whether the documented justifications adequately support a level of services proposed for a patient in the plan for health care services developed for that patient.

Processing may continue at block 324. At block 324, additional user input that may be used for identifying inconsistent or omitted information may be obtained. The information received at block 324 may relate to a risk assessment. The risk assessment, for example, may be obtained through an input area 660 (FIG. 6). In this example, the risk assessment is performed by selecting an assessment from a list of possible assessments. The specific example of FIG. 6 shows four possible assessments, ranging from minimal, to critical. Each possible assessment is associated with a control, such as control 662. A user may specify a risk assessment by selecting the control associated with one of the possible levels of risk presented in display area 660.

Once a user is completed reviewing and modifying values related to diagnoses, conditions, risk factors and any other information that may justify a plan of treatment, the tool may begin analysis of the provided documentation to detect potentially omitted information. Any suitable mechanism may be used to determine when the user has completed input. In the embodiment of FIG. 6, a control 670 is provided. When a user selects control 670, the tool is triggered to perform an initial analysis of the information that may serve as documented justification of a plan for health care services.

Processing performed at decision block 330 represents one such way in which the tool may identify omitted documentation. In this example, the tool may be programmed to associate clinical indicators with diagnoses. Such programming may be achieved, for example, with a data structure linking clinical indicators with diagnoses. The clinical indicators, for example, may be any of the conditions received at block 316 or risk factors indicated through input received at block 322.

Regardless of the manner in which the clinical indicators are determined, the tool may compare diagnoses input at blocks 310 and/or 312 to the clinical indicators determined based on input received at blocks 316 or 322. If, as a result of this comparison, the tool determines that a diagnosis for which clinical indicators have been documented is omitted from the diagnoses received at blocks 310 and/or 312, the process may branch from decision block 330 to block 332.

At block 332, a user may be prompted to verify whether the missing diagnosis is applicable to the patient. Any suitable mechanism may be used to prompt a user at block 332. In an interactive environment, a user may be prompted to verify a potentially missing diagnosis by displaying graphical user interface 400 in the form illustrated in FIG. 4A with display area 430 configured with a list of possible diagnoses, including the missing diagnosis. The list may be displayed in conjunction with a warning banner or other form of output alerting the user to the possible omission of that diagnosis, and allowing the user to select that diagnosis, if applicable to the patient. Though, it should be appreciated, that processing at block 332 may involve prompting the user in any suitable way and need not involve prompting the user in real time by displaying a graphical user interface. As an example of an alternative, report generator 156 (FIG. 1) may generate a report indicating the potentially omitted diagnosis that may be presented to a user at a later time.

Another approach for identifying omitted documentation may be comparing an overall risk assessment provided by a health care provider and the extent of the documentation obtained for risk factors. This comparison may be based on a score for documented risk factors. At block 336, a score for the documented risk factors may be computed. As described above in connection with FIG. 8, the tool may be configured with a data structure, such as data structure 800 associating a score with each possible risk factor. The values associated with the identified risk factors may be combined into a score in any suitable way. In some embodiments, the value associated with each of identified risk factors may be summed to produce an overall score. Though, other approaches for combining risk factors may be used, including averaging or taking the largest value associated with any of the risk factors.

The score computed at block 336 may be used at decision block 340 to determine whether documentation of risk factors has possibly been omitted. Processing at decision block 340 compares the score computed at block 336 for documented risk factors with the overall risk assessment entered by the user at block 324. If the overall risk assessment entered by the user at block 324 indicates a higher level of risk than has been documented, the user may be prompted to review the documented risk factors and, if appropriate, provide additional inputs that may document risk factors that are consistent with the more severe risk assessment input by the healthcare provider at block 324.

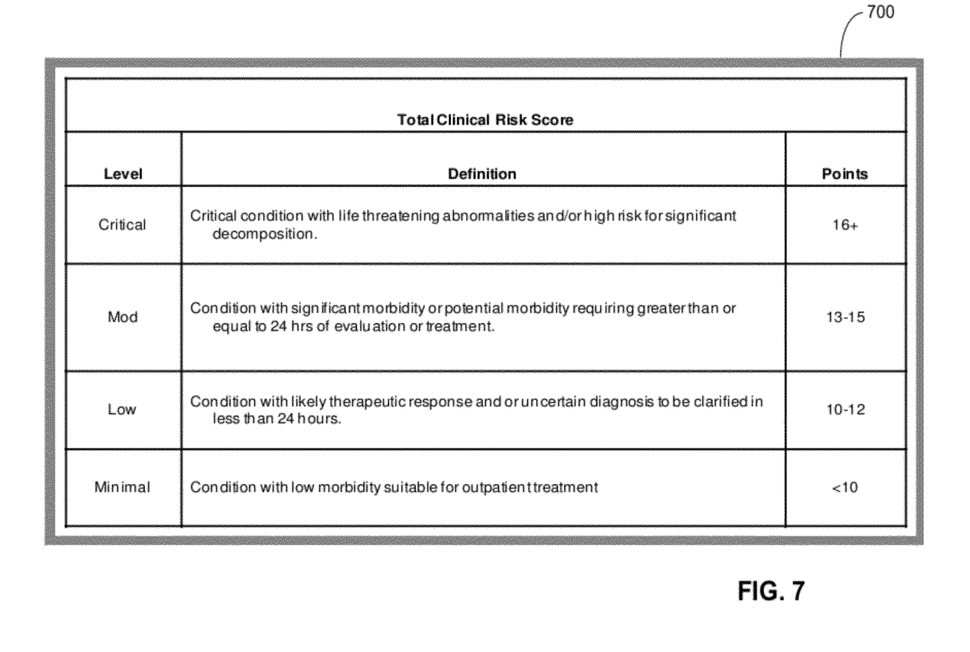

The comparison between risk assessment and risk score may be made based on a data structure associating a value with each of the possible risk assessments that could be entered through display area 660. For example, data structure 700 (FIG. 7) shows that a risk assessment of minimal risk is associated with a value of less than 10. In contrast, an assessment of a low level of risk is associated with a value of 10 to 12. Similarly, an assessment of moderate risk is associated with a value of 13 through 15 and an assessment of critical risk is associated with a value of 16 or more. The risk score computed at block 336 may be compared with these values to select a level of risk based on the documented risk factors. When the level of risk determined by comparing the risk score to the values listed in data structure 700 indicates the same or higher level of risk than is indicated by the risk assessment provided at block 324, the risk score and risk assessment may be regarded as consistent. Conversely, if the risk category determined by matching the risk score to values indicated in data structure 700 indicates a lower level of risk than the risk assessment, the tool may determine that documentation of risk factors possibly has been omitted and the user may be prompted to provide additional justification.

The user may be prompted at block 342 to provide additional justification in any suitable way. As an example, the user may be prompted to review the risk factors input through display area 630 or to enter notes through display area 640. Alternatively, the user may be prompted to input information, that may justify a higher level of health care services than might be apparent based on documented risk factors.

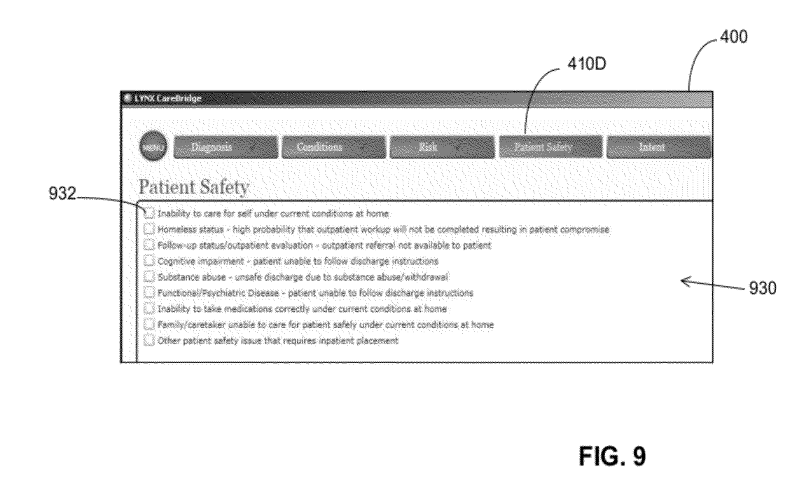

As an example, factors relating to patient safety may influence a healthcare provider's assessment of overall patient risk. Accordingly, if processing at decision block 340 detects an inconsistency between a risk assessment and documented risk factors, a user may be prompted to enter information concerning such other factors. FIG. 9 illustrates that, when tab 410D is selected, graphical user interface 400 may be configured with a display area 930 through which a user may provide input related to patient safety, if the patient is not treated on an inpatient basis, which may explain a difference between a risk assessment and document risk factors.

In this example, possible safety factors are listed in display area 930. Each of the possible factors is associated with a control, such as control 932. A user may select one or more possible factors by selecting their associated controls. The patient safety factors indicated through display area 930 may explain a disposition of the patient, increasing the likelihood that the healthcare facility will receive reimbursement for inpatient services.

Regardless of the manner in which the user is prompted to provide justification for the disparity between risk assessment and documented risk factors, any input received from the user in response to such prompting may be archived. In this way, the additional information may later be retrieved and presented as justification of a plan for health care services based on the more severe risk assessment of the healthcare provider than was documented through recording of applicable risk factors. Though prompting a user to provide additional information at block 342 may entail a small amount of additional work by the user while the user is in the process of making decisions about necessary treatment for a patient, the additional burden of providing this information while it is readily available is likely to require substantially less time from the healthcare provider than would be necessary to recreate the thought process at a future date in response to an audit by a third party payer.

Regardless of whether an inconsistency is detected at decision block 340, the process may proceed either directly to block 350 (FIG. 3B) or indirectly after completion of processing at block 342. At block 350, a documentation score is computed, representing the level of documentation that has been provided of the patient's condition. The score computed at block 350 may be based on documentation of diagnoses and documentation of risk factors. Such an approach may be used when the diagnosis and risk factors are used to determine necessity of health care services for which a third party payer will provide reimbursement. When other factors provide such justification, those other factors alternatively or additionally may be considered in computing the score at block 350.

The documentation score computed at block 350 may be computed in any suitable way. In the embodiment illustrated, the documentation score may reflect both diagnoses input at blocks 310 and/or 312 and documented risk factors, including those selected at block 318 and identified based on input received at block 322. Any suitable mechanism may be used to combine these values. In the embodiment illustrated, the documentation score determined at block 350 is based on selecting the largest individual value associated with a diagnosis or risk factor. Though, alternative computational approaches may be used at block 350. For example, all of the values may be averaged or the largest value associated with a diagnosis may be added to the risk score computed at block 336. As another example, the larger of the risk score computed at block 336 and a value associated with any of the diagnoses identified at block 310 and/or 312 may be selected.

Regardless of the manner in which a documentation score is computed at block 350, the documentation score may be compared to a score indicating an extent of health care services planned for the patient. Inconsistencies between the extent of health care services and documentation supporting that level of health care services may be identified by comparing the documentation score to a score computed based on the planned level of health care services.

Accordingly, process 300 may continue to block 352 where input related to planed health care services may be received. Input related to the planned health care services for a patient may be received in any suitable way. As one example, the input may be received through graphical user interface 400.

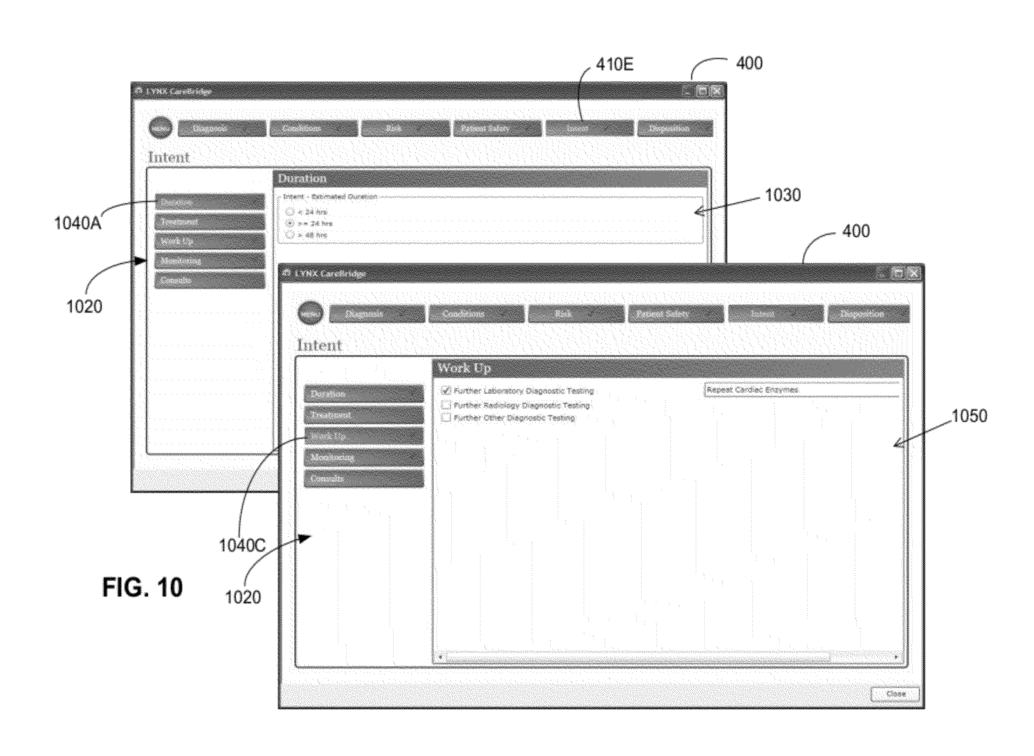

FIG. 10 illustrates an example of graphical user interface 400 configured for receiving input related to health care services intended to be provided for a patient. In this example, graphical user interface 400 has been configured by a user selecting tab 410E. When tab 410E is selected, display area 1020 is presented. Display area 1020 contains controls allowing a user to select categories of information relating to health care services to be provided. Different configurations of graphical user interface 400 may be presented in response to selection of different ones of the controls. For example, FIG. 10 illustrates that selection of control 1040A results in presentation of display area 1030, through which a user may specify an intended duration of treatment of the patient at the healthcare facility. An alternative display area 1050 may be presented in response to a user selection of control 1040C.

In this example, a user may provide input in display area 1030 relating to duration of treatment. Options for specifying an intended duration are presented in terms of time ranges. As a specific example, a user is offered an option, by selecting an appropriate control in display area 1030, of selecting among an intended duration of less than twenty four hours, between twenty four and forty eight hours or greater than forty eight hours. In this example, these ranges are selected because they are relevant to reimbursement decisions made by third party payers. Though, it should be appreciated that any suitable mechanism may be used to specify a duration of treatment.

In this specific example, selection of control 1040C opens a new window containing an additional copy of graphical user interface 400, allowing a user to simultaneously view different categories of input associated with a plan for health care services. In the scenario illustrated in FIG. 10, display area 1050 includes controls through which a user may indicate tests to be performed on the patient as part of the plan for health care services. Other ones of the controls in display area 1020, when selected, may open other windows through which the user may specify other parameters of a plan for providing health care services to the patient.

Regardless of the nature and number of parameters of a plan for health care services collected, once the plan has been specified by the user, the process may proceed to block 354. At block 354, a score may be computed reflecting the level of services included in the plan for health care services. The score computed at block 354 may be computed in any suitable way, taking into account any one or more of the factors input at block 352. In the embodiment illustrated, an intent score reflecting a level of care in the plan for health care services may be based on a subset of the factors. As a specific example, the intent score computed at block 354 may be based only on the duration as specified through display area 1030. Such a computation may be performed by assigning a different value for different durations, with longer durations being assigned higher values. Though, it should be recognized that an intent score may be computed in any suitable way, including by forming the intent score based on factors instead of or in addition to duration of treatment.

Regardless of how the intent score is computed at block 354, the process may proceed to decision block 360, where the process may branch, depending on whether the documented justification for health care services is consistent with the level of health care services planned. The determination of whether the documentation is consistent with the intent may be made by comparing the intent score computed at block 354 to the documentation score computed at block 350. Though, any suitable approach may be used for comparing the level of documented justifications for treatment with the level of intended health care services may be used.

Regardless of the manner in which the comparison is made at block 360, if the documented justifications for health care services are at a lower level than the intended services at part of the planned health services, the process may branch from decision block 360 to block 362. At block 362, the user may be prompted. Prompting at block 362 may alert the user to the possibility of inconsistent documentation and/or may request that the user input additional information that may serve as justification for the plan of health care services. This prompting may appear as audible or visual output to the user through any suitable user interface.

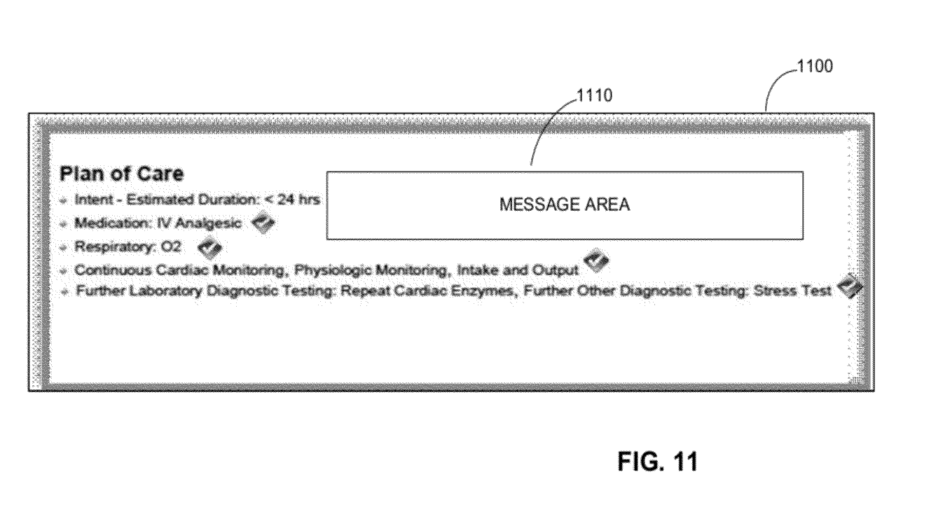

In some embodiments, a user may request the system to output a plan of care, such as plan of care 1100 (FIG. 11). Plan of care 1100 may be generated, such as by report generator 158 (FIG. 1), based on information input by the user at block 352. In the embodiment illustrated in FIG. 11, plan of care 1100 may include a message area 1110 that includes a message for the user indicating whether documented justifications are consistent with a level of services in the plan of care. Though, it should be appreciated that a user may be prompted at block 362 in any suitable way.

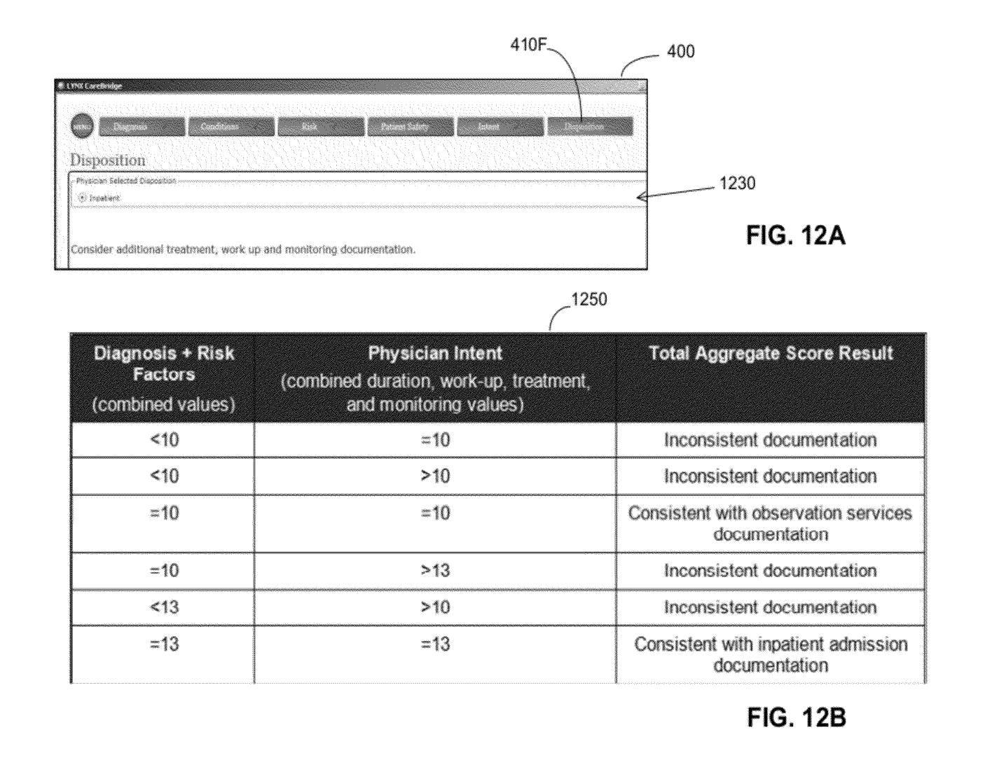

Process 300 may continue to block 364, whether or not the user is prompted at block 362. At block 364, the tool may receive user input related to an intended disposition for the patient. In this scenario, the intended disposition indicates whether the patient will be admitted for treatment or treated as an outpatient. Such information may be received through a graphical user interface 400 as illustrated in FIG. 12A. FIG. 12A illustrates graphical user interface 400 in a scenario in which a user has selected tab 410F. In this state, graphical user interface 400 includes a display area 1230 through which a user may indicate a disposition. In this case, display area 1230 includes a control that a user may select to indicate that the patient is to be treated as an inpatient. The control may be deselected based on user input if the plan for health care services does not call for inpatient treatment. Though, it should be recognized that any suitable mechanism may be used to receive input related to an intended disposition of a patient.

Regardless of the manner in which input is received at block 364, the process may proceed to block 366 where a score for the intended disposition may be determined In this example, a higher score may be assigned when the patient is to be treated as an inpatient. Where more than one disposition is possible, such as dispositions classified based on anticipated duration of a hospital stay or admission to different units, such as a cardiac unit or intensive care unit, different values may be associated with these different possible dispositions.

Regardless of the manner in which a score is assigned to the intended disposition, the process may branch at decision block 370 depending on whether the documented justifications for health care services are consistent with the admission decision reflected in the disposition information obtained at block 364. In the embodiment illustrated, this decision may be based on a comparison of the score computed at block 350 with the score computed at block 366.

If the score computed at block 366 indicates a disposition involving a higher level of services than is justified by the documented justifications, the process may branch from decision block 370 to block 372. At decision block 372, the user may be prompted. As with prompting at block 362, the user may be prompted at block 372 in any suitable way. This prompting may involve generating a warning to the user of the inconsistency between level of services and level of documentation. The warning may include suggestions, including suggestions to review any of the inputs, including those related to diagnoses, conditions, risk factors, or a plan for health care services.

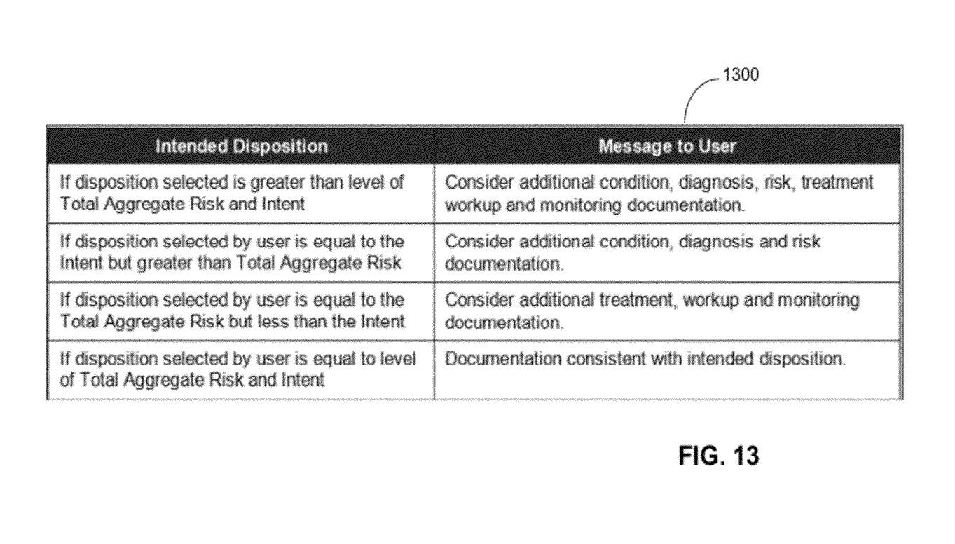

As noted above, prompting a user may include display of a warning message. FIG. 13 illustrates a data table 1300 that may be maintained by the tool reflecting messages that may be presented to the user depending on the relative levels of documented justifications, level of health care services and the intended disposition. These messages, in the example of FIG. 13, may represent messages that may be selected for presentation to the user based as part of processing represented by blocks 362 and 372.

In this example, data table 1300 includes message that may be presented to a user in each of four possible scenarios. These scenarios may be determined based on combined processing such as is illustrated at decision blocks 360 and 370. For example, a first row of data structure 1300 may be regarded as containing a message displayed to a user when the score for an intended disposition as computed at block 366 is greater than both the score computed at block 350, representing documented justifications, and the score computed at block 354, representing a level of intended health care services. In that scenario, the user may be presented with a message such as: “Consider additional condition, diagnosis, risk, treatment workup and monitoring documentation.”

Another row in data structure 1300 may identify a message appropriate for a scenario in which the intended disposition score computed at block 366 is greater than the documented justification score computed at block 350 but not the intent score computed at block 354. In this scenario, the tool may output a message in the form: “Consider additional condition, diagnosis and risk documentation.” A further row in data structure 1300 may contain a message applicable when the intended disposition score computed at block 366 is less than the intent score computed at block 354, but not less than the documented justification score computed at block 350. In this scenario, a message may warn a user to: “Consider additional treatment, workup and monitoring documentation.”

In scenarios in which the intended disposition score computed at block 366 is not less than the documented justification score computed at block 350 or the intended disposition score computed at block 366, the tool may determine that the intended disposition and documented justifications are consistent. In that scenario, no warning may be generated for the user. Though, a user message may be output indicating: “Documentation consistent with intended disposition.”

In this way, a user may receive feedback concerning adequacy of documentation of factors that may justify a plan for health care services. In response to warnings of inadequate documented justifications, a user may opt to provide further input relating to diagnoses or risk factors. In response, all or portions of process 300 may be repeated.

Having thus described several aspects of at least one embodiment of this invention, it is to be appreciated that various alterations, modifications, and improvements will readily occur to those skilled in the art.

In example embodiments, input is described as being received from a user, such as a health care provider, through a graphical user interface. Such a user interface may allow interactive use of the tool while the health care provider is examining a patient or preparing a plan for providing health care services for a patient. Though, it should be appreciated that FIG. 1 illustrates an embodiment in which the tool is operated in an environment that includes one or more clinical data management systems. Any data described as being obtained through a graphical user interface of the tool alternatively or additionally may be obtained from a clinical data management system or other suitable source.

As an example of possible variations, decision block 330 illustrates a form of comparison between severity of diagnosis and level of documented risk. Comparisons in other forms may be made. For example, an overall scores for a diagnosis may be computed and compared to an overall score for risk factors.

As an example of further variations, FIG. 6 shows a scroll bar associated with display area 630 in FIG. 6. Even though not expressly indicated, similar controls may be associated with any of the user interfaces. Likewise, different or additional navigation controls may be displayed to allow a user to control the types of information that is available to view for providing input to or receiving output from the tool. Accordingly, it should be appreciated that any suitable input and output mechanisms may be used at any suitable phase during operation of the tool. Accordingly, input/output mechanisms illustrated in connection with one phase may be used in connection with other phases.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Through, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above. As used herein, the term “non-transitory computer-readable storage medium” encompasses only a computer-readable medium that can be considered to be a manufacture (i.e., article of manufacture) or a machine.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operating a computer system, the method comprising:
with at least one processor:
receiving first input indicating a diagnosis of a patient;
assigning one or more first values based on the diagnosis;
receiving second input identifying one or more values of factors indicating risk for the patient;
assigning one or more second values based on the one or more values of the factors indicating risk;
determining a combined score based on the one or more first values and the one or more second values;
receiving third input indicating intended health care services to be provided to the patient;
determining a health care services score based on the intended health care services;
comparing the determined health care services score to the combined score, and, based on the comparison, selectively outputting a warning of an inconsistency between the intended health care services and a documented justification for the intended heath care services.

2. The method of claim 1, wherein selectively outputting a warning comprises outputting a warning that the intended health care services are inconsistent in response to the comparing indicating that the determined health care services score exceeds the combined score.

3. The method of claim 2, wherein:
determining a health care services score comprises assigning a lower value when the intended health care services involves outpatient services and a higher value when the intended health care services comprises a hospital admission; and
selectively outputting a warning comprises displaying to a user a warning that hospital admission is inconsistent with one or more of a documented diagnosis and documented risks when the intended health care services comprises hospital admission and the health care services score is greater than the combined score.

4. The method of claim 3, further comprising:
archiving information indicative of the first input and the second input.

5. The method of claim 4, further comprising:
generating an audit report based on the archived information.

6. The method of claim 4, further comprising:
identifying based on the second input a clinical indicator of a possible diagnosis;
when the first input does not include the possible diagnosis, prompting a user to consider documenting that the possible diagnosis is applicable to the patient.

7. The method of claim 4, further comprising:
receiving fourth input indicating a risk assessment assigned by a user;
comparing the risk assessment to a risk score computed from at least the one or more second values;
when the comparison indicates that the risk assessment is greater than the computed risk score, prompting the user to provide an explanation of the risk assessment; and
including information indicative of the explanation in the archived information.

8. The method of claim 1, wherein the second input comprises at least one of values of vital signs for the patient and laboratory results for the patient.

9. The method of claim 1, wherein:
the method further comprises receiving customization information for a health care facility, the customization information identifying values associated with diagnoses and values associated with risk factors; and
assigning one or more first values and assigning one or more second values comprises selecting values from the customization information.

10. A non-transitory computer-readable storage medium comprising computer-executable instructions that, when executed by a processor, perform a method comprising:
receiving diagnosis input indicating a diagnosis of a patient;
receiving risk input indicating risk factors for the patient;
receiving a disposition input indicating a disposition of the patient;
determining whether documented justification for health care services according to the indicated disposition are suitable based on a comparison of the indicated disposition to the diagnosis input and the risk factor input.

11. The computer-readable medium of claim 10, wherein:
receiving risk input comprises receiving through a display listing possible risk factors; and
the method further comprises:
selecting a plurality of risk factors associated with the diagnosis;
generating the display for receiving risk input based on the selected risk factors.

12. The computer-readable medium of claim 10, wherein the method further comprises:
when the documented justification is determined to be unsuitable, providing a warning to the user.

13. The computer-readable medium of claim 10, wherein the method further comprises:
prompting a user to supply further risk input when the documented justification is determined to be unsuitable.

14. A method of operating a computer system, the method comprising:
with at least one processor:
receiving first input indicating a diagnosis of a patient;
assigning one or more first values based on the diagnosis;
receiving second input identifying one or more factors indicating risk for the patient;
assigning one or more second values based on the one or more factors indicating risk;
comparing a first score computed based on the one or more first values to a second score computed based on the one or more second values;
when the first score is greater than the second score, prompting a user to provide input further identifying factors indicating risk for the patient.

15. The method of claim 14, further comprising:
receiving third input indicating a disposition of the patient;
assigning a third score based on the indicated disposition of the patient; and
determining a suitability of the indicated disposition based on a comparison of the third score to a combined score based on the one or more first values and the one or more second values.

16. The method of claim 15, wherein:
the combined score comprises a maximum value of the one or more first values and the one or more second values.

17. The method of claim 16, wherein:
the method further comprises receiving input representing first scoring criteria, the first scoring criteria associating each of a plurality of diagnoses with a respective value; and
assigning one or more first values comprises selecting the one or more of the respective values of the first scoring criteria based on the diagnosis.

18. The method of claim 17, further comprising:
storing in computer memory the first scoring criteria with an association with a health care facility.

19. The method of claim 18, wherein:
the at least one processor comprises a processor associated with a server; and
storing the first scoring criteria comprises storing the first scoring criteria in a data store with scoring criteria associated with scoring criteria for each of a plurality of other health care facilities.

20. The method of claim 16, wherein:
the method further comprises receiving user input representing second scoring criteria, the second scoring criteria associating each of a plurality of risk factors with a respective value; and
assigning one or more second values comprises selecting one or more of the respective values of the second scoring criteria based on the one or more factors indicating risk for the patient.

21. The method of claim 14, wherein:
receiving the first input comprises receiving input through a graphical user interface of a computer.

22. The method of claim 14, wherein:
receiving the first input comprises receiving input through an application programming interface from a clinical system.

23. The method of claim 13, wherein:
receiving second input comprises receiving input relating to an objective condition of the patient.

24. The method of claim 23, wherein:
receiving the second input further comprises presenting a graphical user interface comprising possible risk factors applicable to the indicated diagnosis and control elements, each control element being adapted to receive user input indicating a selection of an associated possible risk factor.

25. The method of claim 24, further comprising:
indicating at least a portion of the control elements as selected based on the received user input relating to an objective condition of the patient.
